(19) United States
(12) Patent Application Publication
(10) Pub. No.: US 2013/0097057 A1
(43) Pub. Date: Apr. 18, 2013

(54) SYSTEM AND METHOD FOR GENERATING A CONFIDENCE CRITERION FOR RELATIONSHIPS OVER TELECOMMUNICATIONS NETWORKS

(71) Applicants: Luis Miguel Vaquero Gonzalez, Madrid (ES); Luis Rodero Merino, Palencia (ES)

(72) Inventors: Luis Miguel Vaquero Gonzalez, Madrid (ES); Luis Rodero Merino, Palencia (ES)

(73) Assignee: TELEFONICA, S.A, Madrid (ES)

(21) Appl. No.: 13/643,620

(22) PCT Filed: Dec. 30, 2009
(86) PCT No.: PCT/ES2009/070642

§ 371 Date: Nov. 26, 2012

(51) Int. Cl. G06Q 30/06

(52) U.S. Cl. CPC G06Q 30/0609
USPC 705/26.35

(57) ABSTRACT

A system including a user looking for a candidate user for a telematic operation or transaction within a distributed reputation system; making, in addition to requests for information about reputation to trusted users, other requests for information on reputation to the very candidates, such that the selected candidate is selected because the candidate has a criterion of reputation over the other users that is as similar as possible to that of the user who is searching for a candidate. According to the method, a block of reputation-related data is included in a data-collection step, based on the similarity of reputation-related criteria between a user searching for candidates for an operation and the candidates.

### OBJECT OF THE INVENTION

As expressed in the title of this specification, the present invention relates to a system and method for generating a trust criterion for relationships over telecommunications networks the essential purpose of which consists of providing a system and a method that can be easily automated and implemented with computing and electronic devices for recognizing trusted entities with which to operate and perform transactions in telecommunications and data networks that are used to share information as a business tool and for other access services, the mentioned networks being able to be data networks such as the Internet.

### BACKGROUND OF THE INVENTION

Telecommunications networks are widely used as a business tool to share information and access services. In this context, trust between partners is a key factor and being able to recognize trusted entities with which to operate and perform transactions becomes an essential key advantage for companies. There is very ample literature associated with reputation and trust management, showing the importance of and interest in the problem [8; 25; 26]. The success of Amazon and eBay proves that such reputation systems are useful in promoting trust between vendors and clients, at least for transactions of a relatively small value. However, several issues are still problematic for a more widespread use of the trust-enabling system.

Both Amazon and eBay are examples of centralized reputation systems (see FIG. 5). With a single trusted authority controlling all the trusted information, such systems can be vulnerable or inflexible. Furthermore, centralized systems can be susceptible to scalability problems, which is a crucial problem in the present contexts with an always increasing number of services and users, and therefore of potential transactions. Furthermore, there are some situations in which having a single centralized authority cannot even be done. Distributed trust management systems [25; 26] have been proposed and studied to solve these problems. The management of the distributed trust systems has been an important source of relevant methods, as in P2P networks [9-12] or at electronic commerce sites, as a measure of participant reliability [1; 5; 13].

FIG. 5 of this document shows a typical diagram of a centralized reputation system according to the current state of the art.

Said FIG. 5 comprises the following reference numbers:

51: centralizing entity

52: storage means

53: users of the telecommunications network, such as an agent, a company, an individual or others

54: transactions by means of a telecommunications network with a centralized reputation system

55: information about reputation with a centralized reputation system

On the other hand, in a distributed trust management system each of the participants, i.e., agent in the reputation network, maintains information about how reliable a subset of other members of the same network are (see FIG. 6). These mechanisms and protocols of the system are planned to be normalized by the OASIS Open Reputation Management Systems Technical Committee. This information can be made available for other agents. So when an agent tries to compute how reliable some other agent is, the agent can take into account its own prior experience with it (if any) and the information provided by third parties. There is no central entity storing the information about reputation of all the participants in the system.

FIG. 6 of this document schematically shows a distributed reputation system according to the current state of the art.

Said FIG. 6 uses the following reference numbers:

53: users of the network

64: transactions by means of a telecommunications network with a distributed reputation system

65: information about reputation with a distributed reputation system

Although distributed trust systems improve system scalability, they are often solely based on information about agents in the network with which they have had prior transactions (also called neighbors).

In this respect, many papers only deal with access control systems for the access of users to the available services of a shopping network [17, 18, 19, 20, 21, 22, 23, 24], which is not enough because they lack automatism and are service-specific [16]. Systems where agents cooperate to spread information about reputation in the community were then proposed [29]. It is assumed that each of the agents has neighbors who are in turn connected to their own neighbors. An agent dynamically restructures its trust knowledge using information of trust from its neighbors (recommendations), as shown in FIG. 7 of this document. Said FIG. 7 of the present document shows a typical trust building process in a distributed reputation system according to the current state of the art closest to the present invention. The references in said FIG. 7 are the following:

53: user of the network

53A: user of the network looking for a candidate user for a transaction

53B: user of the network consulted by user 53A

53C: another user of the network also consulted by user 53A

53X: candidate user of the network of 53A for the transaction

53Y: user of the network finally selected by 53A for the transaction

64: transactions performed between users of the network

65: request for information about reputation made in the network to well-known users

71: storage means for storing its own information about the reputation of other nodes of the network

Said FIG. 7 of the state of the art is explained below:

The agent 53A can maintain its own information about the reputation of other nodes by means of its own memory means 71. The agent 53A has therefore put together a list of candidates to perform a transaction (agents 53X and 53Y). The list of candidates can be put together using its own experience, asking the centralized system like a directory, asking other agents. In this sense, the agent 53A can make a request for information about reputation with other agents by means of the information about reputation flows 65. The agent 53A collects the information about reputation about the candidates found 53X and 53Y to make the transaction, said information usually coming from other well-known and trusted agents, such as the mentioned 53B and 53C, and/or from the prior experience of 53A, such that the agent 53A combines the reputation-related data it has obtained and selects the candidate 53Y to perform the transaction 64.

Some of these ways of computing trust lack the dynamism required for the evolution of trust [29]. Mui et al. [7] proposed the adaptive Bayesian formalization to aid in updating information of trust as it changes in the network. This approach still lacks a way of reducing the relative weight of the older data when it is grouped with data collected again, achieved by adding an age function to the trust scores [2].

Even though the evolution of the trust score and age certainly improved precision of distributed trust networks, they still lacked some valuable features increasing precision of available information of trust. Data from the transaction context is used as an important factor when it is added to the feedback from each of the transactions because transactions can differ from one another [3; 14].

None of the preceding approaches deals with robustness, which is understood as the system's capacity to deal with intentional or unintentional tendentious opinions. This feature is crucial so that entities in the network completely trust the system. Without a system capable of reducing the impact of malicious attacks, trust recommendation systems will be rendered useless (not reliable). To aid in distinguishing feedback from reputed agents from feedback from malicious or dishonest agents, the system must compute the reputation scores as close as possible to their actual honesty. Current reputation systems are aimed at the acquisitions of past behavior of the entities, such as credit ratings given by other entities in the system (based on past interactions) or evidence-based systems integrating indirect data (recommendations) with the direct experience of the entity [13]. Traditional methods of combining trust from the references are not efficient in dealing with malicious agents providing tendentious information [15]. Having a statistically reasonable fraction of tendentious/malicious feedback, a common strategy is to filter a large amount of feedback every time it is available. Another approach is to use incentives to provoke honest feedback [6]. However, studies of the eBay reputation system have shown that it is difficult to provoke this feedback. An important reason for such difficulty is the lack of incentives for users. In some communities, users are reluctant to share information out of fear that it will give a competitive advantage to others. Incentive mechanisms deal with this matter by providing incentives to users who provide honest feedback by means of a secondary payment mechanism. The reputation of an agent of the network varies over time in actual systems. Until now, all the aforementioned techniques for increasing precision in the trust of agents of the network have a very important drawback: they cannot be maintained with the rate of change. An expected feature of a reputation grouping is that it should converge “quickly enough” to reflect the true changes of agents' behaviors. However, the meaning of quickly enough depends on the specific nature of the system being considered. The rate of convergence must be parameterizable by the user.

The grouping method is key to explaining the rate of convergence (time for re-evaluating the trust knowledge of an agent). A simple cumulative record of the credit ratings of a user is often used on a member in a determined location on the market due to the high rate of convergence. However, this simple system is open to abuse in situations in which, for example, many positive credit ratings are given fraudulently (unless a truly robust system is implemented). An improved reputation system enhancing robustness is provided by modeling both the reputation of the participants and the required reputation of the participants (a minimum threshold) [28]. However, this approach can lead to high convergence times every time the entities involved are below this threshold value. Furthermore, in large systems in which a high number of entities are interacting, many of them potentially exceed this threshold and the trust of the system will no longer be valid. Xiong and Liu [3] presented an approach that prevents grouping individual interactions. Their PeerTrust system computes the honesty of a client determined as the average weighted feedback of the scores from the feedback originators. The limitation of this approach is that the rate of convergence of the computation in large-scale systems is not provided.

With respect to the problems presented with the existing solutions it should be indicated that in accordance with the large body of evidence presented above, the challenges and drawbacks for distributed reputation systems today have multiplied as described below [4]:

Little precision. As shown in the preceding section, there has been a huge advancement in trust systems towards higher degrees of precision and robustness. However, current solutions still leave room for discrepancies. For example, this could be the case of when a network agent considers a transaction as very satisfactory, increasing the trust of the agent from the other end. However, this latter agent can be rated as responding poorly by a third party in the network. Agents need a mechanism to determine whether their trust criterion is similar to that provided by the network recommendation grouping and its own direct experience.

Low convergence. Simple grouping methods present a quick convergence, though they often show reduced robustness and security against malicious attacks. It is therefore still necessary for systems increasing the robustness of trust scores to maintain the grouping time, and therefore the rate of convergence, at reasonably low values.

High expense. The system should only consume limited computation and bandwidth resources for evaluating and monitoring the trust of the agent.

Furthermore, little work has been done with respect to some topics that are important in actual reputation systems.

Uncertainty. Reputation systems must take into account how ‘certain’ each of the nodes is about the information about reputation it shares concerning the other members of the network. Agents must be capable of representing said certainty, and the control mechanism must take it into account such that the more secure the information is, the more it should be taken into account.

Lack of incentives. To encourage agents to honestly report about the information about reputation they have, there should be some mechanism that rewards participants sharing information they have precisely and at the same time penalize malicious users introducing prejudices. In this point it can again be seen that there is a need to represent the uncertainty: the nodes should be able to say how certain they are about the information about reputation they provide such that they are not worried about being penalized if that information is not precise.

### ABBREVIATIONS AND LITERATURE REFERENCES

OASIS Organization for the Advancement of Structured Information Standards
ORMS Open Reputation Management Systems
[1] Zacharias G. Collaborative reputation mechanisms for online communities. M S Thesis. MIT. 1999.
[2] S. Buchegger and J.-Y. L. Boudec, “A Robust Reputation System for P2P and Mobile Ad-hoc Networks”, Second Workshop on Economics of P2P Systems, Boston, June 2004.
[3] L. Xiong and L. Liu, “PeerTrust: Supporting Reputation-based Trust for Peer-to-Peer Electronic Communities”, IEEE Trans. Knowledge and Data Engineering, Vol. 16, No. 7, 2004, pp. 843-857.
[4] R. Zhou and K. Wang. PowerTrust: A Robust and Scalable Reputation System for Trusted Peer-to-Peer Computing. IEEE Transactions on Parallel and Distributed Systems, Vol. 18, No. 4, 2007, pp. 460-473.
[5] Dellarocas, C. Immunizing online reputation reporting systems against unfair ratings and discriminatory behavior. In: Proceedings of the ACM Conference on Electronic Commerce, Minneapolis, Minn., USA (2000) 150-157.
[6] Jurca, R. and B. Faltings, “An Incentive Compatible Reputation Mechanism”, Proc. of IEEE Conf. on E-Commerce, pp. 285-292, Newport Beach, Calif., June 2003.
[7] L. Mui, M. Mohtsahemi, C. Ang, P. Szolovits, and A. Halberstadt. Ratings in Distributed Systems: A Bayesian Approach. In Proc. of the 11th Workshop on Information Technologies and Systems, New Orleans, La., USA, December 2001.
[8] A. Josang, R Ismail, C Boyd. A Survey on Trust and reputation Systems for Online Service Provision. Decision Support Systems, 43(2), 2007, pp 618-644.
[9] E. Damiani, S. De Capitani Di Vimercati, S. Paraboschi, P. Samarati, F. Violante. A Reputation-Based Approach for Choosing Reliable Resources in Peer-to-Peer Networks. In Proceedings of the 9th ACM Conference on Computer and Communications Security. 2002, pp. 207-216.
[10] Y. Wang and J. Vassileva. Trust and Reputation Model in Peer-to-Peer Networks, Proc. of IEEE Conference on P2P Computing, Linkoeping, Sweden, September 2003, IEEE Press, 150-157.
[11] M. Kinateder and S. Pearson. A Privacy-Enhanced Peer-to-Peer Reputation System. In K. Bauknecht, A. M. Tjoa, and G. Quirchmayr, editors, Proceedings of the 4th International Conference on Electronic Commerce and Web Technologies (EC-Web 2003), volume 2738 of LNCS, pages 206-215, Prague, Czech Republic, September 2003. Springer-Verlag.
[12] R. Aringhieri, E. Damiani, S. De Capitani di Vimercati, S. Paraboschi, P. Samarati: Fuzzy techniques for trust and reputation management in anonymous peer-to-peer systems. JASIST 57(4): 528-537 (2006).
[13] B. Yu and M P. Singh. Distributed Reputation Management for Electronic Commerce. Computational Intelligence. Volume 18, number 4, November 2002, pages 535-549.
[14] Y B. Udupi and M P. Singh. Information Sharing among Autonomous Agents in Referral Networks Systems. (pdf) Proceedings of the 6th International Workshop on Agents and Peer-to-Peer Computing (AP2PC) May 2007.
[15] Y. Wang and M P. Singh. Trust Representation and Aggregation in a Distributed Agent System. Proceedings of the 21st National Conference on Artificial Intelligence (AAAI) July 2006.
[16] M. Gias Uddin and M. Zulkernine. 2009. ATM: an automatic trust monitoring algorithm for service software. In Proceedings of the 2009 ACM Symposium on Applied Computing (Honolulu, Hawaii). SAC '09. ACM, New York, N.Y., 1040-1044.
[17] C. English, S. Terzis, and P. Nixon. 2005. Towards self-protecting ubiquitous systems: monitoring trust-based interactions. Personal Ubiquitous Comput. 10, 1 (December 2005), 50-54.
[18] S. Rajbhandari, A. Contes, O F. Rana, V. Deora, I. and Wootten. 2006. Trust Assessment Using Provenance in Service Oriented Applications. In Proceedings of the 10th IEEE on international Enterprise Distributed Object Computing Conference Workshops (Oct. 16-20, 2006). EDOCW. IEEE Computer Society, Washington, D.C., 65.
[19] T. Ryutov, L. Zhou, C. Neuman, T. Leithead, and K E. Seamons. 2005. Adaptive trust negotiation and access control. In Proceedings of the Tenth ACM Symposium on Access Control Models and Technologies (Stockholm, Sweden, Jun. 1-3, 2005). SACMAT '05. ACM, New York, N.Y., 139-146.
[20] W. Sherchan, S W. Loke, and S. Krishnaswamy. 2006. A fuzzy model for reasoning about reputation in web services. In Proceedings of the 2006 ACM Symposium on Applied Computing (Dijon, France, Apr. 23-27, 2006). SAC '06. ACM, New York, N.Y., 1886-1892.
[21] C. Lin and V. Varadharajan. Trust Based Risk Management for Distributed System Security—A New Approach. In Proceedings of the First international Conference on Availability, Reliability and Security (Apr. 20-22, 2006). ARES. IEEE Computer Society, Washington, D.C., 6-13.
[22] N. Dimmock, A. Belokosztolszki, D. Eyers, J. Bacon, and K. Moody. 2004. Using trust and risk in role-based access control policies. In Proceedings of the Ninth ACM Symposium on Access Control Models and Technologies (Yorktown Heights, N.Y., USA, Jun. 2-4, 2004). SACMAT '04. ACM, New York, N.Y., 156-162.
[23] N. Dimmock, J. Bacon, K. Moody, and D. Ingram. Risk models for Trust-Based Access Control (TBAC). In: 3rd International Conference on Trust Management (iTrust 2005), 22-26 May 2005, Versailles, France.
[24] S. Chakraborty and I. Ray. TrustBAC: integrating trust relationships into the RBAC model for access control in open systems. In Proceedings of the Eleventh ACM Symposium on Access Control Models and Technologies (Lake Tahoe, Calif., USA, Jun. 7-9, 2006). SACMAT '06. ACM, New York, N.Y., 49-58.
[25] http://www.freepatentsonline.com/y2007/0130351.html?query=distributed+reputation&stemming=on
[26] http://www.freepatentsonline.com/y2007/024339.html?query=distributed+reputation&stemming=on
[27] http://www.freepatentsonline.com/y2009/0070130.html?query=distributed+reputation&stemming=on
[28] http://www.freepatentsonline.com/y2007/0192169.html?query=distributed+reputation&stemming=on
[29] S. Abdul-Rahman and S. Hailes. Using Recommendations for Managing Trust in Distributed Systems. In Proc. of IEEE Malaysia International Conference on Communication (MICC '97), Kuala Lumpur.

### DESCRIPTION OF THE INVENTION

To achieve the objectives and prevent the drawbacks indicated in preceding sections, the invention consists of a system and method for generating a trust criterion for relationships over telecommunications networks; the system of the invention is based on a state of the art in which users, such as individuals, companies, agents, clients or others, communicate by means of audio, video, data or any combination thereof over one or several telecommunications networks, for the purpose of performing transactions or other telematic operations, using a distributed reputation system for building trust, i.e., lacking centralizing entity, such that the very user has storage means for storing its own information about the reputation of other nodes of the network, and can make requests for information about reputation to other trusted users to perform the transaction or operation with one of the candidate users.

In a novel manner, according to the system of the invention, said user looking for a candidate for the transaction within said distributed reputation system makes, in addition to the mentioned requests for information about reputation, other requests for information about reputation to the very candidates, such that the candidate user finally selected for the transaction is selected because said candidate has a criterion of reputation over the other users that is as similar as possible to that of the user who is searching for a candidate for the transaction.

The method of the invention can be applied, between others, to a system such as that defined above, having the steps of:
data collection,
data grouping and
decision-making;
   the data collection step being able to have a block for remote collection of reputation-related data by means of an external telecommunications network and a block of reputation-related data coming from the direct experience of the user of the method, said user having its own storage means for storing its own information about the reputation of other nodes of said network.

In a novel manner, the method according to the invention has in the data collection step, in addition to the blocks mentioned in the preceding paragraph, a block of reputation-related data based on the similarity of reputation-related criteria between said user of the method and other users of the network that are candidates for a relationship.

According to a preferred embodiment of this method of the invention, the user of the network establishes trust values for the candidates for a relationship by means of a series of successive operations consisting of:
a) Establishing a list of possible candidates for a relationship in the network by means of local information sources and of neighboring users.
b) Collecting information about the reputation of each of the candidates of said list in a) by means of local information sources and of neighboring users.
c) Requesting information about reputation concerning well-known nodes of the network from the candidates of said list in a).
d) Grouping all the information about reputation in b) and c) and computing a numerical reputation value for each candidate of the list in a).
e) And preparing a final list where each candidate of the list in a) is associated with a weighted numerical value about its reputation.

The essential advantage of the system and method of the present invention consists of extending the investigation mechanism provided in the state of the art, asking the parties of interest about their opinion about well-known parties such that the trust of one entity with respect to another comes to depend on the following three aspects: its own direct experience based on previous transactions; an investigation mechanism by means of questions obtaining information from the neighbors; and an evaluation of the opinions of the candidate agent about the neighbors. This latter evaluation factor for evaluating the opinions of the candidate agent is the key element of the invention which is introduced in a novel manner in distributed trust/reputation systems to provide improvements in the precision, security and incentives of trust scores that can be obtained in an environment integrated in a telecommunications network.

This invention helps to increase precision, assuring that the trust scores received are in accordance with the concept of the agent that it is a good transaction. The proposal of the invention also reduces uncertainty by including a modeling function for modeling how certain an agent is about the information it is sharing in the network. However, the most noteworthy contribution is the establishment of a robust incentive mechanism, encouraging agents to share precise information (reducing the impact of malicious attacks).

Since the mechanism of the present invention is to only add an additional message (directly asking the candidate agent) to obtain data about various neighbors, the incurred expense and the rate of convergence are kept at reasonably low levels, which allows for enormous scalability.

It must be noted that the modification is generic enough to accommodate a broad spectrum of application domains. In other words, each entity developing the system and method of the invention could implement the proposed mechanism to overcome the aforementioned limitations in current distributed systems.

Additionally, the selection of the agent is modified to increase the certainty or uncertainty of the computed trust depending on available data samples, the higher and more recent the sample is the higher the certainty is. Therefore, when an agent provides a trusted measure about a second agent to a third agent, the agent also provides its certainty about that measure. The method proposed in this document is based on a completely distributed approach introducing a minor expense for the network; only two additional messages are required to obtain the trust scores of the target agent: the question from the agent to the candidate agent analyzed and the response.

Since the global trust of the agents of the network (including that of the agent with which there is interest in interacting) is checked against the local “opinion” of the initiator about what a reliable entity is, and the certainty of the information collected is taken into account, the proposed method increases precision and reduces uncertainty. It also introduces a strong incentive to prevent tendentious/malicious recommendations, increasing robustness against malicious attacks of the decision-making process. This is done without reducing scalability and the rapid convergence of the probabilistic grouping methods and without producing a significant additional expense.

To aid in better understanding this specification and forming an integral part thereof a set of drawings are attached below in which the object of the invention has been depicted with an illustrative and non-limiting character.

### BRIEF DESCRIPTION OF THE DRAWINGS

FIG. 1 schematically depicts a system for generating a trust criterion for relationships over telecommunications networks, carried out according to the present invention.

FIG. 2 schematically depicts a method for generating a trust criterion for relationships over telecommunications networks, carried out according to the present invention.

FIG. 3 schematically depicts a series of consecutive operations whereby the method of the preceding FIG. 2 is implemented by means of a functional block diagram.

FIG. 4 depicts a generic method for obtaining a trust criterion in relationships over telecommunications networks according to the current state of the art.

FIG. 5 schematically depicts a system for generating a trust criterion for relationships by means of telecommunications networks belonging to the current state of the art and using a centralized reputation system.

FIG. 6 schematically depicts a system of the current state of the art for generating a trust criterion similar to that of the preceding FIG. 5 but using a distributed reputation system, i.e., without a centralizing entity establishing the reputations.

FIG. 7 depicts a system of the current state of the art for generating a trust criterion in relationships over telecommunications networks which, like that of the preceding FIG. 6, uses a distributed reputation system and can be considered the system of the current state of the art closest to the invention.

### DESCRIPTION OF AN EMBODIMENT OF THE INVENTION

A description of an embodiment of the invention is provided below referring to the references in the drawings.

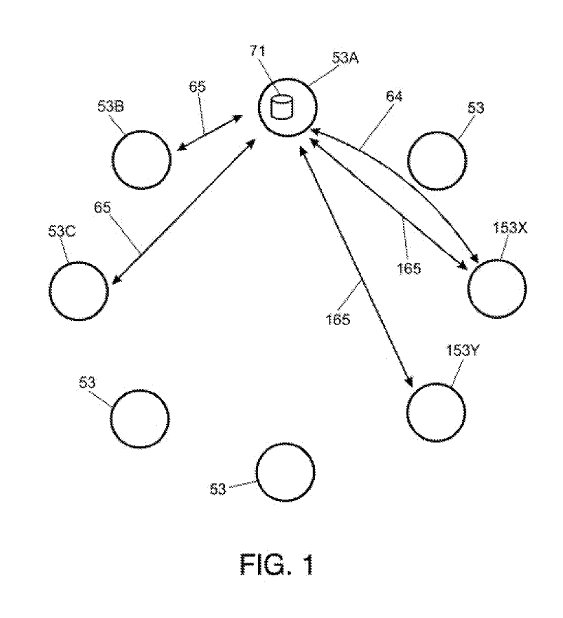

FIG. 1 depicts a system according to the invention with the following references:

53: user of the network

53A: user of the network looking for a candidate user

53B: user of the network consulted by 53A and well-known by 53A

53C: another user of the network well-known by 53A and also consulted by 53A

64: transactions made in the telecommunications network

65: requests for information about reputation made in the telecommunications network with a distributed reputation system

71: storage means for storing its own information about the reputation of other nodes of the network

153X: candidate user of the network finally selected by 53A for a transaction

153Y: candidate user of the network of 53A and finally rejected

165: requests for information about reputation with the distributed reputation system made directly to candidates according to the system and method of the invention.

FIG. 1 shows users of the network which can generally be individuals, companies, agents, clients or others and which communicate by means of audio, video, data or any combination thereof over one or several telecommunications networks for performing transactions 64 or other telematic operations requiring a certain level of trust in the users that are involved.

The system of the embodiment of the invention of FIG. 1 uses a distributed reputation system to build the criteria of trust such that the very user 53A looking for a candidate for the transaction 64 has its own storage means 71 for storing information about reputation of other nodes of the network, further making requests for information about reputation 65 to other trusted users 53B, 53C to perform the transaction 64 with a certain degree of certainty.

The user 53A further makes other requests for information about reputation 165 to the very candidates 153X, 153Y for the transaction, such that the candidate finally selected 153X to perform the transaction 64 is the candidate having a criterion of reputation over the other users of the network that is most similar to that of the user 53A initiating the transaction 64.

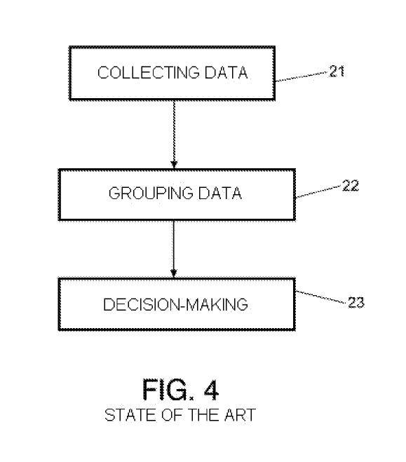

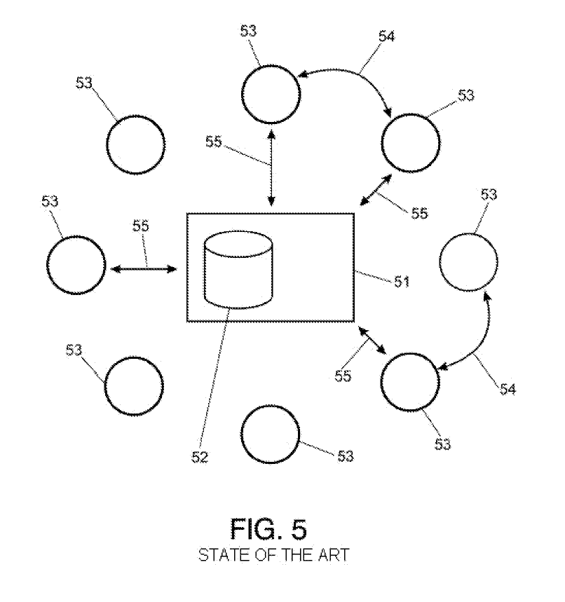

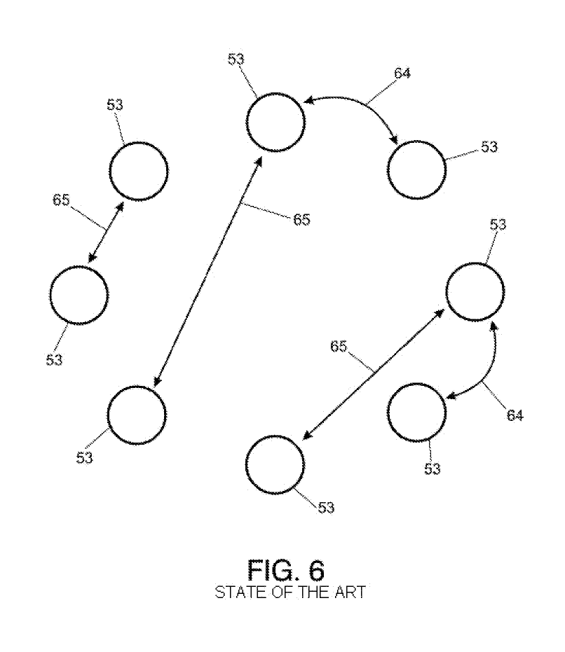

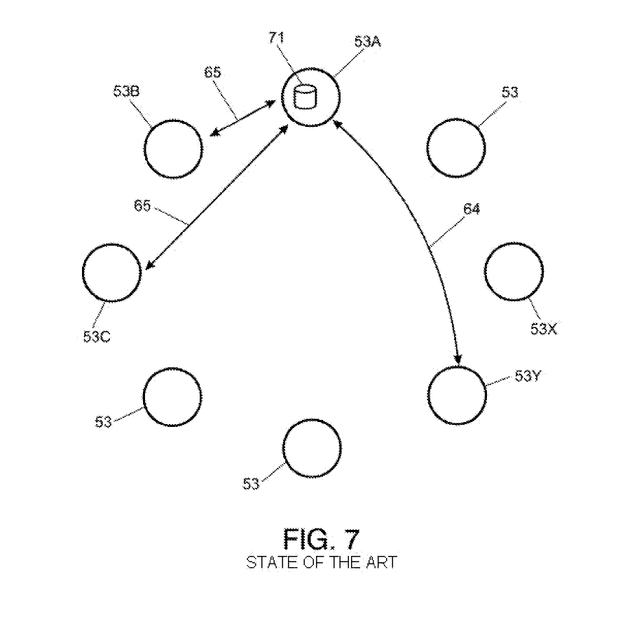

FIGS. 4 to 7 depict a method and several systems of the state of the art, those corresponding to systems (FIGS. 5, 6 and 7) having been explained in the “Background of the Invention” section of this document.

FIG. 4 shows a general method for handling reputation-related data consisting of a first block of data collection 21, a second block of data grouping 22 and a third block of decision-making 23, as depicted in said FIG. 4 of the state of the art.

Said block of data collection 21 conventionally includes a block for remote collection of reputation-related data 31 by means of an external telecommunications network 40 and a block of reputation-related data coming from the direct experience 32 of the user of the method, said user normally having its own storage means 71 for storing its own information about the reputation of other nodes of the network 40.

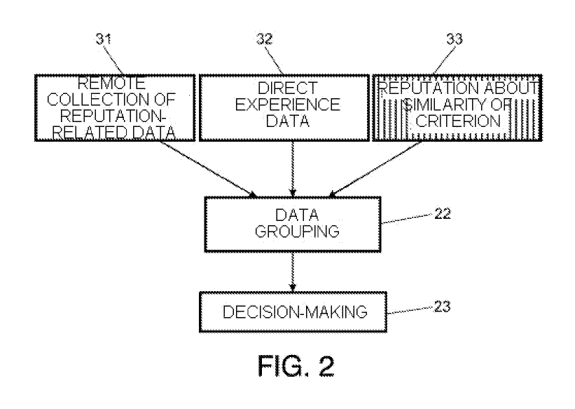

According to the method of the present example of the invention, in addition to the blocks referenced as 31 and 32, the data collection step of the method includes in a novel manner a block of reputation-related data based on the similarity of criterion 33, as depicted in FIG. 2. This block 33 is based on the similarity of reputation-related criteria between the user of the method and other users of the network 40.

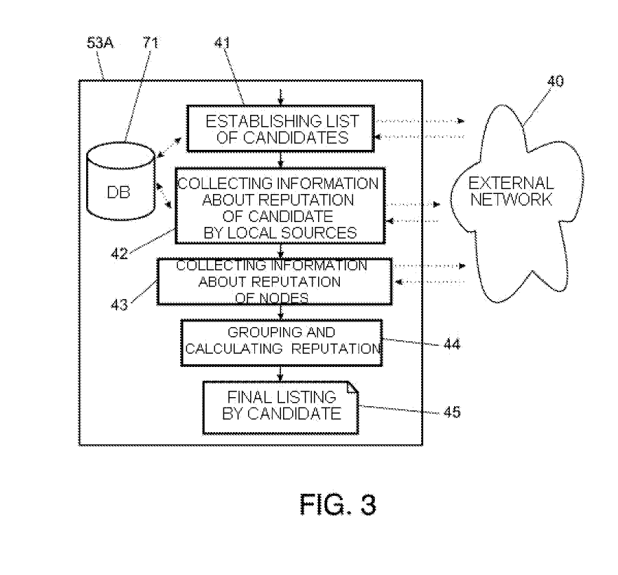

To implement the method of the present embodiment of the invention, a user 53A of the network 40 establishes trust values for the candidates for a relationship by means of a series of successive operations, as depicted in FIG. 3, where the following steps are provided:

41: establishing a list of possible candidates for a relationship in the network 40 by means of local information sources 71 and neighboring users.

42: collecting information about the reputation of each of the candidates of the previously established list 41 by means of local information sources 71 and of neighboring users.

43: request for information about reputation concerning well-known nodes in the network 40 by the user, this information being asked directly from the candidates of the list established in the first step referenced as 41.

44: grouping all the information about reputation obtained in the previous two steps 42 and 43 and computing a numerical reputation value for each candidate of the list of the first step 41.

45: preparing a final list where each candidate of the list of the first step of the implementation 41 is associated with a weighted numerical value about its reputation.

Typical data collection mechanisms collect direct experience and question neighbors about trust-related data concerning the candidate agent, techniques for data grouping, such as probabilistic approaches including Bayesian statistics and evidence-based models, currently being known. According to the embodiment of the invention, said techniques extend to the information collected in a novel manner, such that the grouping process results in a score for all the possible candidate agents, the decision-making 23 being able to consist simply of a selection of the highest score.

To compute the reputation of an agent, the invention takes into account local data based on the experience of the agent and recommendations made by other agents that were previously asked; and furthermore, the weight of each of the recommendations in the final result depends on the degree of trust of the agent that has been consulted and of the certainty that the agent that is being asked has about the information about reputation said agent is providing. Furthermore, since the invention introduces a trust criterion based on similarity of criteria, depicted by means of the block with lines 33 of FIG. 2, the invention is much more precise and reliable than the systems and methods of the state of the art. Therefore, data are contrasted by means of the invention instead of using only information collected remotely or by means of its own experience, as other systems do. In the invention, one agent computes the trust of another not only by collecting personal experience and recommendations, but asks the opinion of said other agent that is its candidate about other agents known by said agent. It is thereby assured that the recommendations or “the network knowledge” about the agents are in accordance with its own criterion. In fact, if the opinion of a candidate agent to a transaction about other agents of the network is similar to the opinion of the agent looking for a candidate, the possibilities that it is being deceived by malicious agents are greatly reduced, and the precision and robustness of the selection can be much greater. Furthermore, a very appealing side effect is produced, consisting of when a specific agents asks a candidate agent about the reputation of another user of the network, the candidate agent that is asked does not know if the agent that is asking is in fact interested in the requested reputation or in the reputation of the candidate agent that is being asked, so the candidate agent being asked is impelled to reply truthfully in order to be considered trustworthy.

On the other hand, the grouping techniques used in the block of data grouping 22 of the method of the invention of FIG. 2 can be traditional grouping techniques including probabilistic approaches such as Bayesian statistics or evidence-based models like the Dempster-Shafer theory, thereby assuring rapid convergences of computation due to low grouping times. Trust is considered multidimensional by means of the invention, including aspects such as competence and purpose.

1. A system for generating a trust criterion for relationships over telecommunications networks, where users, such as individuals, companies, agents, clients or others, communicate by means of audio, video, data or any combination thereof over one or several telecommunications networks (40) for the purpose of performing transactions or other telematic operations using a distributed reputation system for building trust, i.e., lacking a centralizing entity, such that the very user has storage means for storing its own information about the reputation of other nodes of the network and can make requests for information about reputation to other trusted users to perform the transaction or operation with one of its candidate users; characterized in that said user looking for a candidate user for the transaction in that distributed reputation system makes, in addition to the mentioned requests, other requests for information about reputation to the very candidates, such that the candidate user finally selected for the transaction is selected because said candidate has a criterion of reputation over the other users that is as similar as possible to that of the user who is searching for a candidate for the transaction.

2. A method for generating a trust criterion for relationships over telecommunications networks that can be applied, among others, to a system such as that of claim 1, and comprising the steps of:
data collection
data grouping, and
decision-making;
the data collection step being able to have a block for remote collection of reputation-related data by means of an external telecommunications network and a block of reputation-related data coming from the direct experience of a user of the method, said user having its own storage means for storing its own information about the reputation of other nodes of said network, characterized in that in addition to the mentioned blocks, the data collection step has a block of reputation-related data based on the similarity of reputation-related criteria between said user and other users of the network that are candidates for a relationship.

3. The method for generating a trust criterion for relationships over telecommunications networks according to claim 2, characterized in that said user of the network establishes trust values for the candidates for a relationship by means of a series of successive operations consisting of:
a) establishing a list of possible candidates for a relationship in the network by means of local information sources and of neighboring users;
b) collecting information about the reputation of each of the candidates of said list in a) by means of local information sources and of neighboring users;
c) requesting information about reputation concerning well-known nodes of the network from the candidates of said list in a);
d) grouping all the information about reputation in b) and c) and computing a numerical reputation value for each candidate of the list in a); and
preparing a final list where each candidate of the list in a) is associated with a weighted numerical value about its reputation.
